(19) United States
(12) Patent Application Publication
(10) Pub. No.: US 2002/0045373 A1
(43) Pub. Date: Apr. 18, 2002

(54) Movable connector

(76) Inventor: Masaaki Iwasaki, Yokohama (JP)

Correspondence Address: Tyco Technology Resources, Suite 450, 4550 New Linden Hill Road, Wilmington, DE, 19808, US

(21) Appl. No.: 10/008,210

(22) Filed: Nov. 8, 2001

(30) Foreign Application Priority Data
Oct. 11, 2000 (JP) 2000-343890

(51) Int. Cl. H01R 13/64

(52) U.S. Cl. 439/246

(57) ABSTRACT

A movable connector is provided which is more compact, reduces the attachment area on the board, increases the strength of attachment to the board, and increases the reliability of electrical connections. The movable connector has an insulating housing, contacts held in the vicinity of the mating portion of this housing, and retention legs (metal attachment members) held in the housing and fastened to the board. Each retention leg has a mounting portion mounted on the housing, and an attachment portion attached to the board and connected to the mounting portion in a position that is removed from the surface of the circuit board in the upward direction. Since the contacts and retention legs are flexible with respect tot he housing, a movable connector is obtained that can move over the surface of the board so that any positional deviation with the mating connector can be absorbed.

### FIELD OF THE INVENTION

The present invention relates to an electrical connector which is attached to the circuit board, and more specifically relates to a movable connector which absorbs positional deviations between the connectors when engaged with a mating connector.

### BACKGROUND OF THE INVENTION

Connectors of this type generally have a floating mechanism which is used to absorb, i.e., compensate for, positional deviation between connectors. For example, the movable connector disclosed in Japanese Utility Model Publication No. 5(1993)-33479 is known. In this movable connector, an insulative housing has openings which are formed in the vicinity of both ends of a base portion formed as a flange. Attachment members which have a pair of elastic legs are molded as integral portions of the insulating housing inside these openings. This movable connector is mounted on a board by the elastic legs being inserted into attachment holes in the board and fastened in a manner that allows displacement. Consequently, slight positional deviations that occur during engagement with a mating connector can be absorbed by the displacement of the movable connector, so that correct engagement is possible.

In the movable connector, since the attachment members are made of an insulative synthetic resin, the size of the elastic legs must be increased in order to achieve increased retention strength of the connector on the panel. Consequently, the size of the movable connector is also increased. Furthermore, since the elastic legs are made of a synthetic resin, the legs cannot be soldered to the board, so that there are limits to the attachment strength.

### SUMMARY OF THE INVENTION

The present invention was devised in view of the above. An object of the present invention is to provide a compact movable connector in which the attachment area on the circuit board is small, the strength of the attachment to the board is high, and the reliability of electrical connections is also high.

The movable connector of the present invention has an insulating housing which is carried on a circuit board. The housing has a mating portion that engages with a mating connector attached from a direction perpendicular to the surface of the circuit board. At least two flat-plate metal attachment members are provided which have mounting portions that are fastened to the housing and attachment portions that extend from these mounting portions and are fastened to the circuit board. The contact(s) are fastened to the housing in the vicinity of the mating portion so that these contact(s) are movable relative to the housing along the surface of the circuit board. The attachment portions of the attachment members are connected to the mounting portions in position that are separated from the surface of the circuit board in an upward direction so that the attachment portions can move along the surface relative to the mounting portions.

### BRIEF DESCRIPTION OF THE DRAWINGS

The invention will now be described by way of example with reference to the accompanying figures of which:

FIG. 1 is a front view of the movable connector of the present invention.

FIG. 2 is a plan view of the movable connector shown in FIG. 1.

FIG. 3 is a side view of the movable connector shown in FIG. 1.

FIG. 4 is a bottom view of the movable connector shown in FIG. 1.

FIG. 5 is a sectional view of the movable connector along line 5-5 in FIG. 2.

FIG. 6 is a partial enlarged sectional view of the movable connector along line 6-6 in FIG. 2.

FIG. 7 is a front view of the housing used in the movable connector shown in FIG. 1.

FIG. 8 is a plan view of the housing used in the movable connector of the present invention.

FIG. 9 is a side view of the housing shown in FIG. 8.

FIG. 10 is a bottom view of the housing shown in FIG. 8.

FIG. 11 is a front view of the alignment plate.

FIG. 12 is a plan view of the alignment plate shown in FIG. 11.

FIG. 13 is a side view of the alignment plate shown in FIG. 11.

FIG. 14 is a bottom view of the alignment plate shown in FIG. 11.

FIG. 15 is a sectional view of the alignment plate along line 15-15 in FIG. 12.

FIG. 16 is a front view of one of the retention legs.

FIG. 17 is a side view of the retention leg shown in FIG. 16.

FIG. 18 is a bottom view of the retention leg shown in FIG. 16.

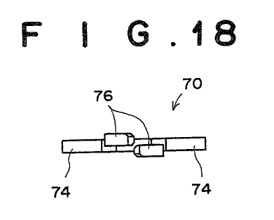

FIG. 19 is a partial enlarged sectional view of the housing along line 19-19 in FIG. 10.

FIG. 20 is a partial enlarged sectional view of the housing along line 20-20 in FIG. 9.

### DETAILED DESCRIPTION OF THE PREFERRED EMBODIMENTS

Below, a preferred embodiment of the movable connector (hereafter referred to simply as a “connector”) of the present invention will be described in detail with reference to the attached figures.

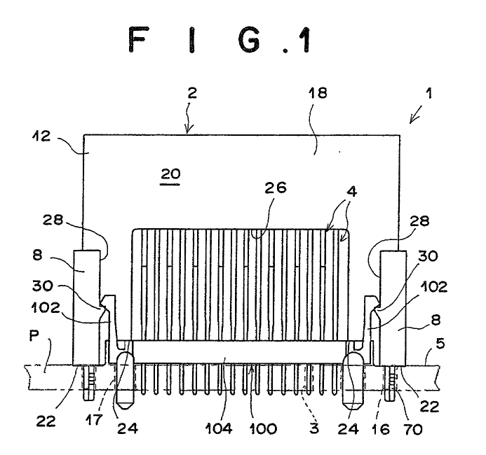

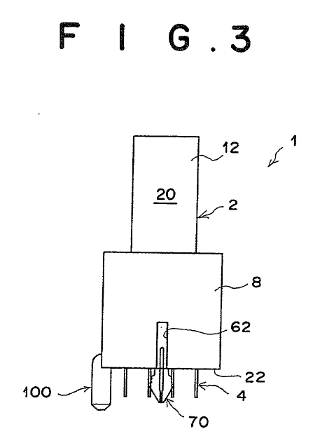

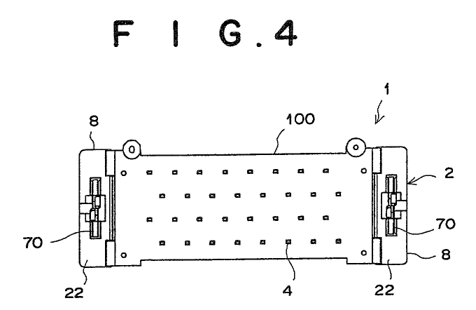

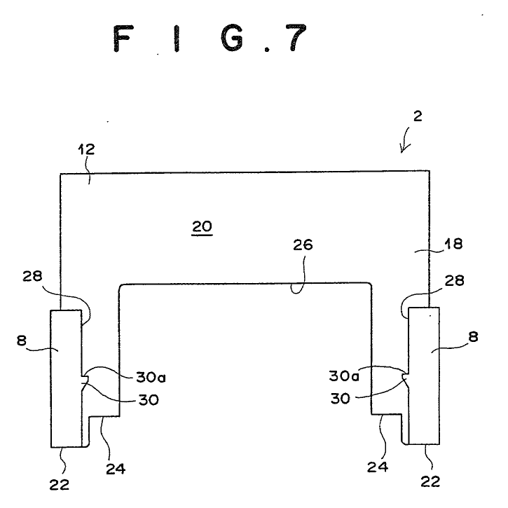

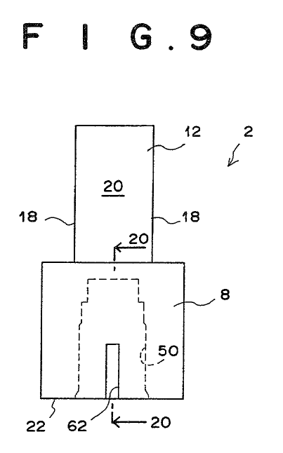

Referring first to FIGS. 1-4, the connector 1 has a substantially rectangular insulating housing 2 which is mounted on a circuit board P, a plurality of contacts 4 which are held in this housing 2, and an insulative alignment plate 100 which is anchored to the housing 2 and which positions the contacts 4. The housing 2 will now be described with reference to FIGS. 7 through 10 as well. The housing 2 has a mating portion 12 which engages a mating connector (not shown in the figures) in the upper portion of the main body 20 of the housing 2.

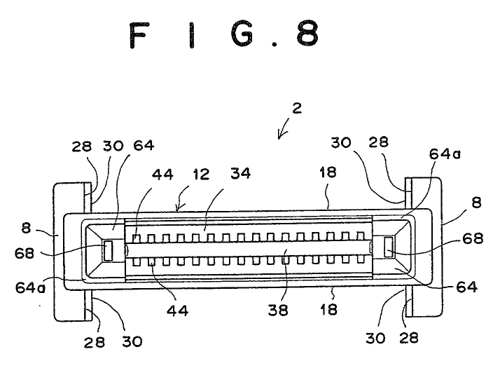

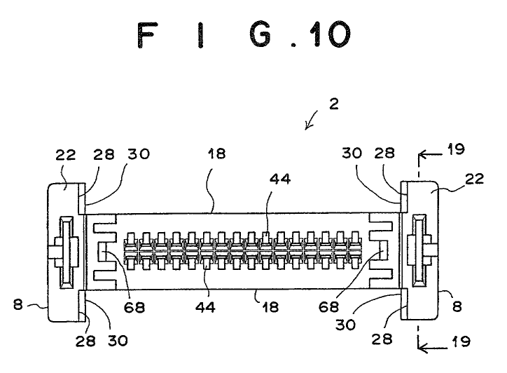

Rectangular wide portions which protrude outward from the main body 20 are formed on both end portions of the main body 20. The bottom surfaces 22, of these wide portions 8, are located on the surface 5 of the board P. The wide portions 8 protrude from both side walls 18, of the main body 20 so that these wide portions 8 face each other on the sides of the side walls 18 (FIGS. 8 and 10). Anchoring projections 30 which have upward-facing surfaces 30a (Figure &) are formed on the facing surfaces 28 of these wide portions 8 in positions that face each other roughly in the centers of the wide portions 8. Latching arms 102 of the alignment plate 100 are anchored on these anchoring projections 30.

As is shown in FIGS. 1, 5, and 7, a rectangular cut-out 26 which cuts across the main body 20 is formed via step portions 24 in the side walls 18 between the wide portions 8. The shape of this cut-out 26 on the sides of the wide portions 8 has recesses and projections, as is shown most clearly in FIG. 10. This is done in order to prevent deformation caused by molding sinks for example. Contact sections 48 of the contacts 4, which extend toward the alignment plate 100 from the mating portion 12, are disposed in a portion of this cut-out 26. The contact sections 48 disposed in this portion are prevented by this cut-out 26 from interfering with the housing 2 during the movement of the housing 2 during engagement with the mating connector. Accordingly, there is no restriction of the floating function of the connector 1. In other words, when the connector is engaged with the mating connector, the housing 2 can move freely along the surface 5 of the board P without interfering with the contacts 4 fastened to the board P, so that positional deviation between the connectors can be absorbed. Furthermore, the alignment plate 100 is disposed in the step portions 24; however, this will be described in greater detail below.

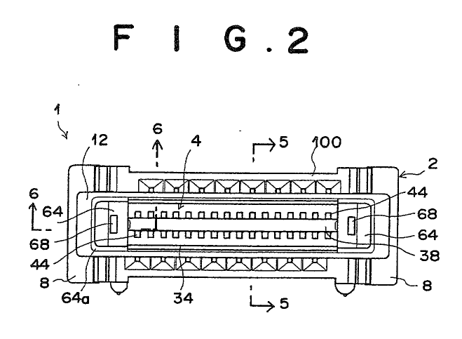

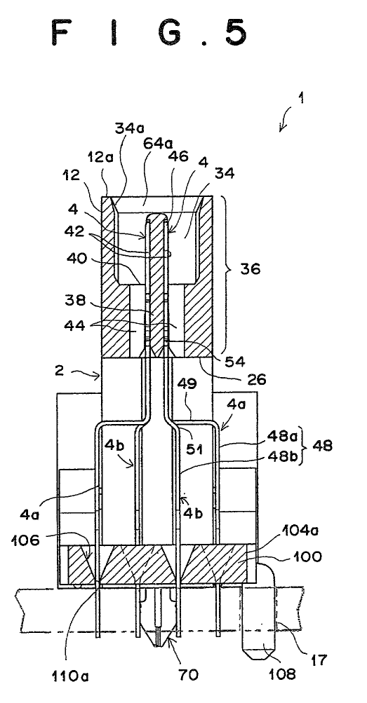

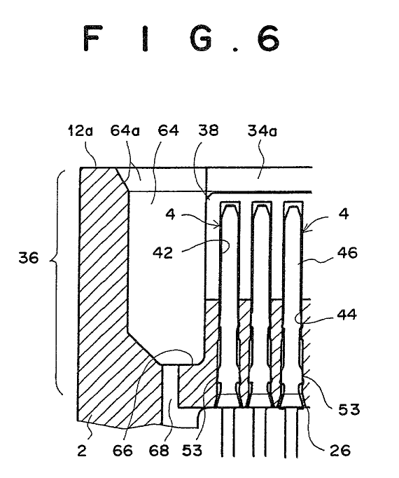

Next, the mating portion 12 of the housing 2 will be described. The plan shape of the mating portion 12 of the housing 2 is shown in FIGS. 2 and 8. This mating portion 12 will be described with additional reference being made to FIGS. 5 and 6. An engaging recess 34 with a long slender plan shape, into which the mating connector is inserted is formed in the mating portion 12 of the housing 2. As is shown most clearly in FIG. 5, the depth of the engaging recess 34 reaches an intermediate point in the direction of height of the upper region 36. Furthermore, the upper region 36 indicates a portion that extends from the cut-out 26 to the upper end or the engaging surface 12a, of the housing 2.

A rib 38 which extends in the direction of length is formed in the engaging recess 34 so that this rib protrudes as an integral portion of the housing 2 in the mating direction of the connector 1 from the center of the bottom surface 40 of the engaging recess 34 (FIG. 5). Grooves 42 extending in the vertical direction for the installation of the contacts 4 are formed in both sides of this rib 38 at specified intervals along the direction of length of the rib 38. These grooves 42 extend to the vicinity of the tip end of the rib 38, which has a curved surface. Furthermore, contact receiving holes (hereafter referred to simply as “receiving holes”) 44 which communicate with the engaging recess 34 and cut-out 26 are formed in the vertical direction (in FIG. 5) in the upper region 36 in alignment with the grooves 42. The contacts 4 are pressfit in these receiving holes 44 from below, and disposed in the grooves 42. Furthermore, tapered surfaces 34a are formed in engaging recess 34 in the vicinity of the engaging surface 12a.

Furthermore, as is shown most clearly in FIG. 6, guide holes 64 which have a substantially rectangular plan shape are formed in both end portions of the engaging recess 34 along the mating direction. Guide projections (not shown in the figures) on the mating connector whose tip ends have a convergent shape are inserted into these guide holes 64 when the connectors are mated with each other, so that the connectors are aligned with each other prior to the electrical engagement of the contacts with each other. These guide holes 64 have tapered surfaces 64a in the portions that open at the engaging surface 12a. The tapered surfaces 64a have a more gradual inclination than the tapered surfaces 34a. In other words, the area that is projected in the mating direction is larger in the case of the tapered surfaces 64a than in the case of the tapered surfaces 34a, so that the guide holes 64a and guide projections can compensate for a larger positional deviation. Discharge holes 68 which have a rectangular cross-sectional shape, and which communicate with the cut-out 26, are formed in the bottom surfaces 66 of the guide holes 64. After the connector 1 is soldered to the board P, the solder flux is cleaned away. These discharge holes 68 are used to discharge the cleaning liquid from the guide holes 64.

Next, the contacts 4 disposed in the grooves 42 will be described. The contacts 4 are shown most clearly in FIGS. 5 and 6; these contacts 4 are formed by stamping and forming metal plates into a long slender shape. The contacts 4 have tip end portions that are fastened to the rib 38 or contact portions 46 that make contact with the mating contacts, and contact sections 48 which are bent at an intermediate point of each contact 4 and which drop downward toward the board P. Two types of contacts 4a and 4b are used in which the shape of the bent portion that is bent at an intermediate point is different. Specifically, there are contacts 4a which have a large bent portion 49, and contacts 4b which have a small bent portion 51.

The contact sections 48a of the contacts 4a are disposed on the outside of the alignment plate 100 (described later), while the contact sections 48b of the contacts 4b are disposed on the inside of the alignment plate 100. These contacts 4a and 4b are alternately disposed along the direction of length of the rib 38. A plurality of barbs 53 are formed on both side edges of the contact portions 46 of the contacts 4 facing the receiving holes 44, in positions that are separated along the direction of length of the contacts 4. When the contacts 4 are press-fitted in the receiving holes 44, these barbs 53 engage the inside walls of the receiving holes 44, so that the contacts 4 are fastened in place in the receiving holes 44. Specifically, the contacts 4 are fastened to the housing 2 by press-fitting in the vicinity of the mating portion 12.

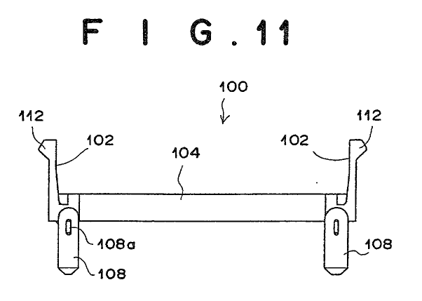

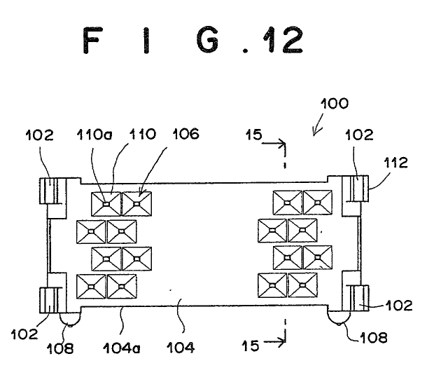

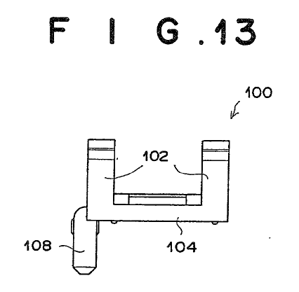

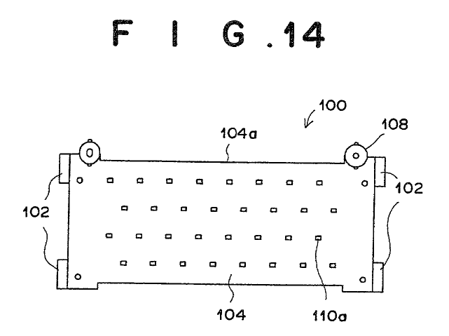

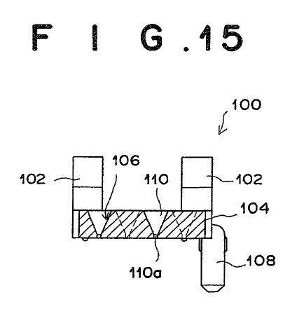

Next, the alignment plate 100 will be described. Furthermore, in this description, reference will also be made to FIGS. 11 through 15. The alignment plate 200 is molded from an insulative material such as a synthetic resin, and has a 5 substantially rectangular flat plate portion 104. A plurality of guide holes 106 which are used to guide the contacts 4 are formed in this plate portion 104 (see FIGS. 12 and 15).

The guide holes 106 have shapes that converge inward from square openings 110 formed in the surface of the plate portion 104. These guide holes 106 communicate with small holes 110a that pass through to the opposite side of the plate portion 104. The contact sections 48 of the contacts 4 are guided by the guide holes 106, and are passed through these small holes 110. The guide holes 106 are arranged to align with the contact sections 48. The contact sections 48a of the contacts 4a are disposed in the outside rows of guide holes 106, and the contact sections 48b of the contacts 4b are disposed in the inside rows of guide holes 106.

Furthermore, positioning posts 108 which are passed through positioning holes 17 in the board P (see FIGS. 1 and 5) are formed on both end portions of the side edge 104a on one side of the plate portion 104. These positioning posts 108 position the alignment plate 100 in the correct position on the board P, and are used in order to achieve a smooth disposition of the contact sections 48 in the through-holes 3 of the board P. For this purpose, the system is arranged so that the tip ends of the positioning posts 108 engage with the board P before the tip ends of the contact sections 48 when the connector 1 is mounted on the board P. Ribs 108a which extend in the vertical direction are formed so that they protrude from the outside surfaces of the positioning posts 108. This is done in order to ensure that the positioning posts 108 will not interfere with the inside walls of the positioning holes 17 when the positioning posts 108 are inserted into the positioning holes 17.

Latching arms 102 are integrally formed as protruding portions on the four comers of the plate portion 104 such that these latching arms 102 stand upright. Outward-facing projections 112 are formed on the front end portions of the latching arms 102. These projections 112 engage with the engaging projections 30 of the housing 2 when the alignment plate 100 is disposed on the step portions 24 of the housing 2 to secure the alignment plate 100 to the housing 2.

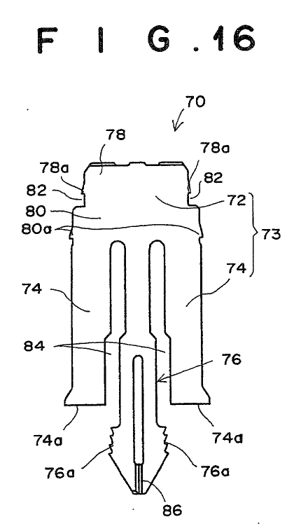

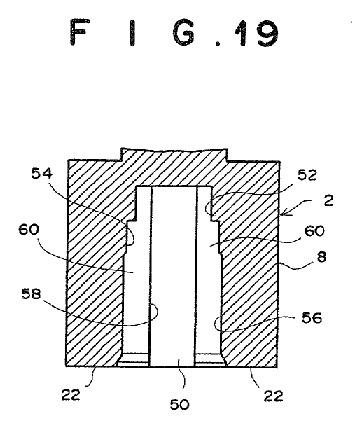

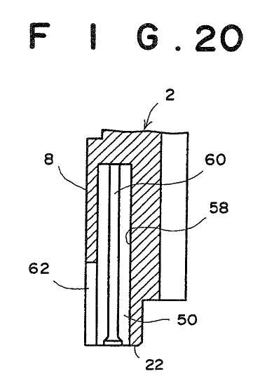

Next, the retention legs 70, which are attached to the insides of the wide portions 8 of the housing 2 will be described with reference to FIGS. 16 through 16. Furthermore, this description will also make reference to FIGS. 19 and 20. Each retention leg 70 is a flat plate member which is integrally formed by stamping from a single metal plate. Each retention leg 70 has a base portion 72, a pair of arms 74 which extend downward from the lower ends of both sides of this base portion 72, and a long slender attachment portion 76 which extends further than the arms 74 from the base portion 72 at a point between these arms 74.

The base portion 72 consists of an upper portion 78 which is on the upper side in FIG. 16, and a lower portion 80 which is wider than the upper portion 78, and which is located on the lower side beyond cut-outs 82 formed in the side edges. Barbs 78a and 80a are respectively protrude in the plane of the plate from both side edges of the upper portion 78 and lower portion 80. In FIG. 16, the arms 74 that extend downward from both end portions of the lower portion 80 are formed so that the end edges 74a of the arms 74 extend perpendicular to the length of the arms 74. Slots 64 are formed between these arms 74 and the attachment portion 76 is located between the arms 74. The slots 84 have a shape in which the lower portions of the slots 84 are shifted to the outside at an intermediate point along the length.

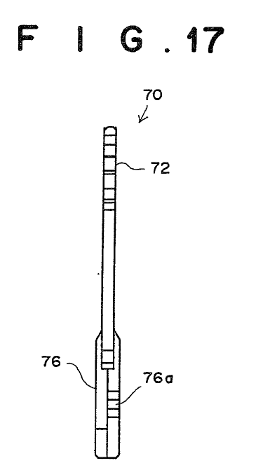

The lower portion of the attachment portion 76 expands outward, and a plurality of barbs 76a are formed on this expanded portion so that these barbs face outward. A cut-out 86 which extends from the tip end of the attachment portion 76 to roughly the middle of the attachment portion 76 is formed along the central axial line extending in along the length of the attachment portion 76. The tip end portion of this cut-out 86 is narrow, while the rear end portion is relatively wide. The portions of the attachment portion 76 that are split by the cut-out 86 are offset from each other in the direction of thickness of the retention leg 70 in the vicinity of the upper end of the cut-out 86, and in the cut-out area (FIG. 17).

Next, the attachment grooves 50 in the housing 2 to which the above-mentioned retention legs 70 are attached will be described with reference to FIGS. 19 and 20. The attachment grooves 50 are grooves that are formed in the vertical direction in the wide portions 8 of the housing 2. These grooves 50 open in the bottom surface 22. As is shown in FIG. 19, each attachment groove 50 consists of an inside portion 52 which has a relatively narrow width, an intermediate portion 54 with a relatively large width which is adjacent to this inside portion 52, and a receiving portion 56 which reaches the bottom surface 22 and which is slightly wider than the intermediate portion 54. Furthermore, the central portion 58 of each attachment groove 50 which extends in the vertical direction has a gap that is sufficiently large to accommodate the positionally- shifted attachment portion 76; moreover, the side portions 60 positioned on both sides of the central portion 58 are formed so that there is a gap that is slightly larger than the plate thickness.

When the retention legs 70 are inserted into these attachment grooves 50, the base portions 72 and arms 74 of the retention legs 70 advance along the side portions 60 of the attachment grooves 50. Furthermore, these base portions 72 and arms 74 are referred to as the “mounting portions” 73, and the retention legs 70 are mounted on the housing 2 by means of these mounting portions 73. In order to insert the retention legs 70 into the attachment grooves 50, the end portions 74a of the arms 74 of the retention legs 70 are pressed and inserted from beneath the housing 2 a tool (not shown in the figures).

When the upper portion 78 and lower portion 80 of the base portion 72 are respectively positioned in the inside portion 52 and intermediate portions 54 of the corresponding attachment groove 50, the barbs 78a and 80a respectively interfere and engage the inside walls of the inside portion 52 and intermediate portion 54. As a result, the retention leg 70 is fastened in place in the corresponding attachment groove 50. The positionally- shifted attachment portion 76 is positioned in the central portion 58 of the corresponding attachment groove 50. Since the retention legs 70 are plate shaped portions, the attachment portions that are attached to the housing 2 are small. Accordingly, the housing 2 can be made more compact. Furthermore, the cut-outs 62 are portions where portions of the mold used to reinforce the mold pins that mold the attachment grooves 50 are disposed.

In order to attach the connector 1 to the board P, the contacts 4 are first aligned with the through-holes 3 in the board P. The attachment portions 76 of the retention legs 70 are also aligned with the anchoring holes 16 in the board P. Both the contacts 48 and retention legs 70 are urged through the connector 1, into the respectively corresponding through-holes 3 and anchoring holes 16 from above the board P. When the attachment portions 76 are urged into the anchoring holes 16, the split tip end portions of the attachment portions 76 are inserted while being offset inward toward each other, and the barbs 76a on the attachment portions 76 interfere and engage with the inside walls of the anchoring holes 16. As a result, the retention legs 70 are fastened to the board P. Since the tip end portions of the split attachment portions ?6 are positionally shifted relative to each other, there is no interference with the mutual deformation of the tip end portions even if the tip end portions are deformed so that they approach each other inside the anchoring holes 16. Accordingly, smooth Insertion can be accomplished without any need for an excessive insertion force. Since the retention legs 70 are formed from metal plates, the retention legs 70 themselves have improved strength, and are resistant to breaking (unlike legs formed from a synthetic resin). Since the contact sections 48 of the contacts 4 and attachment portions 76 of the retention legs 70 attached to the board P are respectively fastened to the board P by soldering, the attachment strength is greatly increased.

When the connector 1 thus fastened is to be engaged with a mating connector, the guide projections of the mating connector and the guide holes 64 of the connector 1 are first engaged. Specifically, the guide projections are inserted into the guide holes 64. As a result, both connectors are aligned and the positional deviation of the connectors is absorbed. In this case, the housing 2 moves along the surface 5 of the board P as a result of the flexing of the contact sections 48 of the contacts 4 and the flexing of the attachment portions 76, so that this positioning is possible.

In the attachment members 70, slots 84 are present between the attachment portions 76 and the arms 74, and the attachment portions 76 have a long slender shape. Accordingly, the housing 2 can move in the direction perpendicular to the thickness of the retention legs 70, i.e., in the left-right direction in FIG. 16. Furthermore, since the attachment portions 76 can easily flex in the direction of thickness of these portions as well, the housing 2 can move in all directions along the surface 5 of the board P, so that any positional deviation can be absorbed.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

The metal attachment members may be integrally formed by stamping metal plates; furthermore, the mounting portions of the metal attachment members may be constructed from a base portion which is fastened to the housing and a pair of arms that extend from this base portion, and the attachment portions may be constructed so that these attachment portions extend further than the arms from the base portion at a point between the arms.

The term “flat-plate-form” does not require that the shape be a completely smooth plate shape, but includes states in which there is some displacement from the surface of the plate in some portions.

What is claimed is:

1. A movable connector comprising:
an insulating housing which is mounted on a circuit board, and which has a mating portion that engages with a mating connector attached from a direction perpendicular to a surface of the circuit board, and at least one contact that faces the mating portion and is connected to the circuit board;
and at least two flat-plate metal attachment members which have mounting portions that are fastened to the housing and attachment portions that extend from these mounting portions and are fastened to the circuit board; wherein
the contacts are fastened to the housing in the vicinity of the mating portion so that these contacts are movable relative to the housing along the surface of the circuit board; and,
the attachment portions of the attachment members are connected to the mounting portions in positions that are separated from the surface of the circuit board in an upward direction so that the attachment portions can move along the surface relative to the mounting portions.

2. The movable connector claimed in claim 1 wherein the metal attachment members are integrally formed by stamping metal plates.

3. The movable connector claimed in claim 1 wherein the mounting portions of the metal attachment members each consist of a base portion which is fastened to the housing and a pair of arms that extend from the base portion.

4. The movable connector claimed in claim 1 wherein the attachment portions extend further than the arms from the base portion at a point between the arms.
